(19) United States
(12) Patent Application Publication
(10) Pub. No.: US 2024/0367478 A1
(43) Pub. Date: Nov. 7, 2024

(54) DUAL-FLOW CLIMATIZATION SYSTEM

(71) Applicant: Gentherm GmbH, Odelzhausen (DE)

(72) Inventors: Scott Richard Wolas, Pasadena, CA (US); Spencer Bennett Banks, Northville, MI (US); Aaron Paul Martin, Brighton, MI (US); Heidi Elizabeth Crandall, Northville, MI (US)

(21) Appl. No.: 18/580,763

(22) PCT Filed: Jul. 19, 2022
(86) PCT No.: PCT/IB2022/000442

§ 371 Date: Jan. 19, 2024

Related U.S. Application Data
(60) Provisional application No. 63/224,590, filed on Jul. 22, 2021.

(51) Int. Cl. B60H 1/00

(52) U.S. Cl. CPC B60H 1/00285; B60H 1/00021; B60H 1/00678; B60H 2001/00135

(57) ABSTRACT

A dual-flow climatization system and a climatized vehicle component incorporating the same. The dual-flow climatization system comprises one or more air movers and an air directing unit. The air directing unit comprises a heat exchanger and a bypass channel. The air directing unit includes a first portion and a second portion. The one or more air movers provide a first airstream to the first portion and a second airstream to the second portion.

### FIELD

The present teachings generally relate to a dual-flow climatization system and a climatized vehicle component incorporating the same.

### BACKGROUND

Some climatized vehicle components (e.g., seats) employ conditioned air to cool and/or heat vehicle occupants. The conditioned air can be sourced from inside the vehicle, such as the cabin of the vehicle within which occupants are situated.

In some climatized components, thermoelectric devices are employed to cool and/or heat air that is delivered to occupants. The thermoelectric devices are sometimes employed in cooperation with a passive heat exchanger (i.e., a thermally conductive material such as aluminum which directly communicates heat between the thermoelectric device and another medium via conduction), which is in contact with a main side and/or waste side of the thermoelectric device.

In other climatized seats, an active heat exchanger, such as a fin and tube type heat exchanger, is employed to cool and/or heat air that is delivered to a seat occupant. A working fluid (e.g., glycol, or a water and glycol mixture) is heated or cooled elsewhere in the vehicle and is supplied to the tubes of the active heat exchanger, where the fins conduct heat between the tubes and another medium via conduction. One benefit to active heat exchangers is the utilization of existing thermodynamic processes in the vehicle, such as the utilization of heat generated from internal combustion engines and/or batteries. However, due to the space required to accommodate fluid flow, active heat exchangers can be larger than passive heat exchangers that are configured to condition a comparable volume of air per unit time.

An increasing number of passenger comfort features are being included in some conventional vehicles, particularly in the seats of such vehicles. For instance, a single vehicle seat can include air delivery devices in the seat bottom, seat back, headrest, and even other areas of the seat. As the number of passenger comfort features increase, the volume of air required to be conditioned correspondingly increases. As a result, the size of climatization systems generally increases proportionally. However, the packaging space for climatization systems within vehicles is limited. Thus, the competing interests of heating and/or cooling capacity and packaging space must be balanced.

It would be desirable to provide a climatized vehicle component that utilizes the heating and/or cooling mechanisms of fluid conditioning systems in vehicles.

It would be desirable to provide a climatization system utilizing an active heat exchanger that is sufficiently sized to fit within relatively small packaging spaces within a vehicle.

It would be desirable to provide a climatization system utilizing an active heat exchanger that is sufficiently sized to fit on or proximate to an underside of a vehicle seat and/or within a vehicle seat.

It would be desirable to provide a climatization system that can simultaneously condition two or more airflows, including airflows flowing in different or even opposing directions.

It would be desirable to provide a climatization system that can supply conditioned air to a plurality of air delivery devices in a climatized vehicle component that delivers air to occupants.

It would be desirable to provide a climatization system that can deliver air to air delivery devices located in a seat bottom, a seat back, a headrest, or any combination thereof.

It would be desirable to provide a climatization system that can respond to occupant and/or autonomous commands to adjust air temperature.

### SUMMARY

The present disclosure relates to a dual-flow climatization system, which may address at least some of the needs identified above. The dual-flow climatization system may comprise: one or more air movers, an air directing unit, or both. The air directing unit may comprise a heat exchanger and a bypass channel. The air directing unit may include a first portion and a second portion. The one or more air movers may provide a first airstream to the first portion and a second airstream to the second portion.

The one or more air movers may provide the first airstream to the first portion in a first direction and the second airstream to the second portion in a second direction. The first direction may oppose the second direction.

The one or more air movers may provide the first airstream to the first portion and the second airstream to the second portion in the same direction.

The heat exchanger may comprise a supply conduit and a return conduit that fluidly communicates with a climatized air system, an engine cooling system, a battery cooling system, a vehicle component conditioning system, or any combination thereof. The system with which the heat exchanger fluidly communicates may heat and/or cool a working fluid that is delivered to the heat exchanger.

The heat exchanger may heat and/or cool the first airstream and the second airstream. A temperature of the first airstream and/or a temperature of the second airstream travelling through the bypass channel may be substantially maintained from an inlet of the air directing unit to an outlet of the air directing unit.

The air directing unit may comprise one or more air directing members that route the first airstream and the second airstream to the heat exchanger, the bypass channel, or both. The one or more air directing members may be doors or flaps.

The one or more air directing members may be angularly translated about a rotational axis by one or more actuators. The one or more actuators may comprise a stepper motor or a servo motor. The one or more actuators may angularly translate an arm about the rotational axis. The arm may be coupled to the one or more air directing members.

In a first mode, the air directing member may route the first airstream and/or the second airstream exclusively through the heat exchanger. In a second mode, the air directing member may route the first airstream and/or the second airstream exclusively through the bypass channel. In one or more third modes, the air directing member may route an airstream through both of the heat exchanger and the bypass channel. The first airstream routed through the heat exchanger and the first airstream routed through the bypass channel may mix proximate to an outlet of the air directing unit. The second airstream routed through the heat exchanger and the second airstream routed through the bypass channel may mix proximate to an outlet of the air directing unit.

A climatized vehicle component may comprise the dual-flow climatization system described above. The climatized vehicle component may include a seat bottom, a seat back, a seat bolster, a back bolster, a headrest, a dashboard, a headliner, a door panel, a pillar, a footwell, a floor section, a center console, or any combination thereof.

The one or more air movers may be located on or proximate to an underside of the climatized vehicle seat.

The present disclosure relates to a dual-flow climatization system, which may address at least some of the needs identified above. The dual-flow climatization system may comprise: one or more air movers, and an air directing unit. The air directing unit may comprise a heat exchanger and a bypass channel. The air directing unit may include a first portion and a second portion. The one or more air movers may provide a first airstream to the first portion in a first direction and a second airstream to the second portion in a second direction. The first direction may oppose the second direction.

The present disclosure contemplates that the first portion and/or the second portion may be free of a heat exchanger, a bypass channel, an air directing member, or any combination thereof. In this regard, an airstream may travel in the first portion and/or the second portion solely through a heat exchanger or a bypass channel.

The present disclosure contemplates that the air directing unit comprises one or more additional portions. The one or more additional portions may be provided an airstream by dedicated air movers or an air mover can supply an airstream to two or more portions of the air directing unit.

The heat exchanger may comprise a supply conduit and a return conduit that fluidly communicates with a climatized air system, an engine cooling system, a battery cooling system, a seat conditioning system, or any combination thereof.

The heat exchanger may heat or cool the first airstream and the second airstream. A temperature of the first airstream and/or a temperature of the second airstream travelling through the bypass channel may be substantially maintained from an inlet of the air directing unit to an outlet of the air directing unit.

The air directing unit may further comprise one or more air directing members that route the first airstream and the second airstream to the heat exchanger, the bypass channel, or both. The one or more air directing members may be doors or flaps. The one or more air directing members may be angularly translated about a rotational axis by one or more actuators. The one or more actuators may comprise a stepper motor or a servo motor. The actuator may angularly translate an arm about the rotational axis. The arm may be coupled to the one or more air directing members.

In a first mode, the air directing member may route the first airstream and the second airstream exclusively through the heat exchanger. In a second mode, the air directing member may route the first airstream and the second airstream exclusively through the bypass channel. In one or more third modes, the air directing member may route an airstream through both of the heat exchanger and the bypass channel. Fluid routed through the heat exchanger and fluid routed through the bypass channel may mix proximate to an outlet of the air directing unit.

The one or more air movers and the air directing unit may be located on or proximate to an underside of a climatized vehicle seat.

The present disclosure relates to a climatized vehicle seat, which may address at least some of the needs identified above. The climatized vehicle seat may comprise at least a first air delivery device and a second air delivery device, and an air directing unit. The at least first air delivery device and second air delivery device may deliver air to one or more passengers. The air directing unit may comprise an air directing member angularly translated about a rotational axis by an actuator. The air directing member may route air to the first air delivery device, the second air delivery device, or both.

The air directing unit may be supplied the air by the dual-flow climatization system according to the present teachings.

The air directing member may be a door or a flap. The air directing member may be coupled to the actuator by an arm. The actuator may angularly translate the arm about the rotational axis. The actuator may comprise a stepper motor or a servo motor.

In a first mode, the air directing member may route the air exclusively to the first air delivery device. In a second mode, the air directing member may route the air exclusively to the second air delivery device. In one or more third modes, the air directing member may route the air to both of the first air delivery device and the second air delivery device.

The air directing unit may be located in a seat bottom, a seat back, or both. The first air delivery device may deliver air to an occupant of the climatized vehicle seat, and the second air delivery device may deliver air to another vehicle occupant. The first air delivery device and the second air delivery device may be selected from a port or air distribution device.

The climatized vehicle component may include a seat bottom, a seat back, a seat bolster, a back bolster, a headrest, a dashboard, a headliner, a door panel, a pillar, a footwell, a floor section, a center console, or any combination thereof.

The air directing unit may be located in a seat bottom, a seat back, or both.

The first air delivery device may deliver air to an occupant of a seat in which the air directing unit is located. The second air delivery device may deliver air to another vehicle occupant.

### BRIEF DESCRIPTION OF THE DRAWINGS

FIG. 1 is a plan view of a vehicle.

FIG. 2 is a plan view of a climatized vehicle seat.

FIG. 3A is a perspective view of a dual-flow climatization system.

FIG. 3B is a perspective view of a dual-flow climatization system.

FIG. 4A is a sectional view of a first portion of an air directing unit along line A-A of FIG. 3A.

FIG. 4B is a sectional view of a first portion of an air directing unit along line A-A of FIG. 3A.

FIG. 4C is a sectional view of a first portion of an air directing unit along line A-A of FIG. 3A.

FIG. 5 is a perspective view of a heat exchanger.

FIG. 6A is a perspective view of a climatized vehicle seat.

FIG. 6B is a perspective view of a climatized vehicle seat.

FIG. 7A is a perspective view of a climatized vehicle seat.

FIG. 7B is a perspective view of a climatized vehicle seat.

FIG. 7C is a perspective view of a climatized vehicle seat.

FIG. 8A is a perspective view of a climatization system.

FIG. 8B is a perspective view of a climatization system.

### DETAILED DESCRIPTION

The present teachings meet one or more of the above needs by the improved dual-flow climatization system and climatized vehicle component described herein.

The climatized vehicle component of the present disclosure may be employed on or in a vehicle. The vehicle may include any typical consumer or commercial vehicle. The vehicle may include sedans, station wagons, hatchbacks, crossover sports utility vehicles, sports utility vehicles, vans, pickup trucks, semi-trucks, construction vehicles, the like, or any combination thereof. The vehicle may be an internal combustion engine vehicle, electric vehicle, or hybrid vehicle. As referred to herein, an electric vehicle may be a vehicle that is powered exclusively by one or more electric motors and a hybrid vehicle may be a vehicle that is powered by at least two different types of power sources (e.g., an internal combustion engine and one or more electric motors).

The vehicle may include an engine bay, front cargo area (“front trunk”), cabin, rear cargo area, or any combination thereof. One or any combination of the engine bay, front cargo area, cabin, and rear cargo area may contain at least a portion of the fluid conditioning system of the present disclosure. The cabin may contain at least a portion of the dual-flow climatization system of the present disclosure.

The vehicles may include one or more vehicle seats. Vehicle seat, as referred to herein, may be any seat or device used to support an occupant or goods. The vehicle seat may include one or more cushions or other support devices on which or against which an occupant or goods may be seated, stored, or transported. The vehicle seat may include a driver's seat, front passenger seat, rear passenger seat, or any combination thereof. The vehicle seat may be a bucket seat or bench seat. The vehicle seat may comprise a seat cushion, a seat back, a headrest, one or more seat cushion bolsters, one or more seat back bolsters, or any combination thereof. The seat bottom may be adapted to interface with an occupant's buttocks and/or legs. The seat back may be adapted to interface with an occupant's back, shoulders, and/or neck. The headrest may be adapted to interface with an occupant's head and/or neck.

While the teachings herein may refer to the dual-flow climatization system as being located in or on a climatized vehicle seat, the dual-flow climatization system of the present teachings may be located anywhere in a vehicle and/or provide air to any component of a vehicle. For example, the air dual-flow climatization system and/or components thereof may be located in and/or direct air to a dashboard, headliner, door panels, pillars, footwells, floor sections, or center consoles of a vehicle, or any combination thereof. The foregoing may be applicable to all aspects of the present teachings.

The vehicle component may be a climatized vehicle component. The climatized vehicle component may function to heat and/or cool a seat occupant. The climatized vehicle component may include one or more air delivery devices that deliver conditioned air to a cabin of a vehicle and/or to a vehicle occupant. The air delivery devices may heat and/or cool a vehicle occupant by delivering conditioned air, ambient air, or a mixture of both to the vehicle occupant.

As referred to herein, conditioned air may be ambient air that is heated or cooled.

Ambient air, as referred to herein, may be air located inside of the cabin of the vehicle, air located inside any other portion of the vehicle (e.g., a rear cargo area), air located outside of the vehicle, or any combination thereof. Ambient air may be conditioned to alter the temperature of the ambient air to a temperature desired by a vehicle occupant.

The climatized vehicle component may comprise one or more dual-flow climatization systems, conduits, air delivery devices, or any combination thereof.

The climatized vehicle component may comprise one or more air delivery devices. The air delivery devices may function to expel air, distribute air across a surface, direct air toward a vehicle occupant, or any combination thereof. The air delivery devices may be located in one or more vehicle components.

The air delivery devices may be located in a seat bottom, a seat back, one or more seat bottom bolsters, one or more seat back bolsters, a headrest, or any combination thereof. The air delivery devices may be located in, under, and/or above one or more seat cushions. The air delivery devices may be located under and/or at least partially extend through seat upholstery.

The air delivery devices may direct air toward one or more anatomical regions of a vehicle occupant. Air may be directed to a vehicle occupant's head, neck, shoulders, back, chest, arms, hands, torso, legs, feet, or any combination thereof.

The air delivery devices may include one or more ports, air distribution devices, or both. Non-limiting examples of suitable air distribution devices (“fluid distribution devices”) are described in U.S. Pat. Nos. 7,338,117 B2 and U.S. Pat. No. 8,539,624 B2; and U.S. Application Publication No. 2009/0218855 A1; all incorporated herein by reference in their entirety for all purposes. The expelled air may be conditioned air, ambient air, or a mixture of both conditioned and ambient air.

Air delivery devices of a climatized vehicle component may direct air to one or more vehicle occupants. For example, an air delivery device located in a driver seat may direct air to an occupant of the driver seat and an occupant of a rear passenger seat located directly behind the driver seat.

The climatized vehicle component may comprise one or more conduits. The conduits may function to transport air from a dual-flow climatization system to one or more air delivery devices.

The conduits may comprise one or more vanes. The vanes may function to direct the airstream, influence the turbulence of the airstream, or both. The vanes may project from an inner surface of the conduits. The vanes may project into the path of the airstream. The vanes may be located anywhere along the length of the conduits. The vanes may be located proximate to an air directing unit. The vanes may be present on any conduit of the present teachings through which air flows.

One or more air delivery devices may be in fluid communication with a dual-flow climatization system via one or more conduits. The conduits may be coupled to both a dual-flow climatization system and one or more air delivery devices. The conduit may comprise one or more bent portions, generally straight portions, or both.

The conduit may extend from an underside of a climatized vehicle seat to elsewhere on or proximate to an underside of the seat, a seat bottom, a seat back, a headrest, or any combination thereof.

The vehicle occupant may select the temperature of air being delivered by one or more air delivery devices by interacting with an electronic control system. The electronic control system may include one or more human-machine interfaces. The human-machine interfaces may include dials, buttons, sliders, touch-screens, the like, or any combination thereof. The vehicle occupant may actuate and/or otherwise interact with one or any combination of dials, buttons, sliders, touch-screens, the like, or any combination thereof to control the temperature of air being delivered to the vehicle occupant. The electronic control system may control the actuator of the dual-flow climatization system. The electronic control system may communicate with a vehicle control unit.

The electronic control system may employ one or more sensors to detect a temperature of a vehicle occupant, one or more structures of a vehicle interior (e.g., seat surface, center console, steering wheel, and/or door panel), ambient air, air exiting one or more air delivery devices, air mixed within or proximate to the air directing unit of the present teachings, or any combination thereof. The sensors may include negative temperature coefficient thermistors, resistance temperature detectors, thermocouples, the like, or any combination thereof.

The temperature of air delivered to a vehicle occupant may be adjusted or fine-tuned by an autonomous system. The autonomous system may control the temperature of air delivered to an occupant without any input from the occupant. That is, the temperature of air being delivered to the occupant may be adjusted or fine-tuned without the occupant actuating any dials, buttons, sliders, or otherwise interacting with an electronic control system. The autonomous system may track occupant preferences. Occupant preferences may comprise a historical database of air temperatures desired by one or more occupants. The autonomous system may utilize one or more sensors and/or occupant preferences to autonomously control the temperature of air being delivered to the occupant. The autonomous system may direct the actuation of one or more air directing members (e.g., doors or flaps) to adjust a proportion of air that travels through the heat exchanger and/or bypass channel; and/or to adjust the mixing of separate airstreams. By way of this adjustment, the temperature of air exiting the air directing unit can be adjusted or fine-tuned, without the need for additional heaters or coolers downstream of the air directing unit.

Based on one or more temperature measurements from the thermometers or probes and/or on a temperature set by an occupant, an actuator of the dual-flow climatization system may move one or more air directing members (e.g., doors or flaps) to adjust a proportion of air that travels through the heat exchanger and/or bypass channel. By way of this adjustment, a temperature of air exiting the air directing unit and flowing into the cabin and/or towards an occupant can be adjusted or fine-tuned, without the need for additional heaters or coolers downstream of the air directing unit.

The vehicle may comprise one or more fluid conditioning systems. The fluid conditioning system may function to heat and/or cool a working fluid, transport a working fluid within a vehicle, exchange heat with air, or any combination thereof. The fluid conditioning system may be provided by the original equipment manufacturer (OEM) or may be an aftermarket installation.

The working fluid may exchange heat with an atmosphere surrounding a vehicle, ambient air within a vehicle, an internal combustion engine of a vehicle, one or more batteries of a vehicle, or any combination thereof. The fluid conditioning system may heat a working fluid by causing the working fluid to compress. The fluid conditioning system may cool a working fluid by causing the working fluid to expand. The working fluid may exchange heat with air, such as air that is delivered to a cabin of a vehicle or air of the atmosphere surrounding the vehicle.

The fluid conditioning system may be a climatized air system, an engine cooling system, a battery cooling system, a vehicle component conditioning system, the like, or any combination thereof.

The climatized air system may function to provide heating and/or cooling to air delivered to the cabin of a vehicle. The climatized air system may fluidly communicate with ports located on and/or in a dashboard, headliner, door panels, pillars, footwells, floor sections, or center consoles of a vehicle, or any combination thereof.

The engine cooling system may function to absorb heat from an engine and dispose of the heat elsewhere such as the atmosphere surrounding the vehicle and/or air delivered to a cabin of a vehicle. The engine may be an internal combustion engine or an electric motor.

The battery cooling system may function to absorb heat from one or more batteries and dispose of the heat elsewhere such as the atmosphere surrounding the vehicle and/or air delivered to a cabin of a vehicle. The one or more batteries may power one or more electric motors such as in a hybrid or electric vehicle.

The vehicle component conditioning system may function to provide heating and/or cooling to a vehicle component. The vehicle component conditioning system may be separate from the dual-flow climatization system of the present teachings.

The fluid conditioning system may include one or more conduits. A working fluid may flow through the one or more conduits. The working fluid may include a refrigerant (e.g., R134a, R1234yf, or the like) or coolant (e.g., water and/or glycol). The working fluid may function, at least in part, to transport and exchange heat.

The fluid conditioning system may include a hot-side, a cold-side, or both. The hot-side may include one or more conduits downstream of a vehicle component from which heat is absorbed by a working fluid or otherwise imposed on the working fluid (e.g., by compression). The cold-side may include one or more conduits upstream of a vehicle component from which heat is absorbed by a working fluid or otherwise imposed on the working fluid (e.g., by expansion).

The terms “hot-side” and “cold-side” are referred to herein with respect to the temperature of the working fluid being transported in each respective side of the fluid conditioning system. In other words, the working fluid of the hot-side is characterized by a temperature that is greater than the temperature of the working fluid of the cold-side.

The fluid conditioning system may include one or more other components generally known in the art to be employed with such systems. These other components may include but are not limited to compressors, expansion valves, air movers such as blowers or pumps, condensers, evaporators, heater cores, radiators, reservoir tanks, supplemental heating and/or cooling devices, the like, or any combination thereof.

The climatized air system may employ one or more supplemental heating devices and/or one or more supplemental cooling devices. The supplemental heating devices may provide heat to air. The supplemental cooling devices may draw heat from air. The supplemental heating devices may provide heat that is supplemental to the heat provided by other vehicle components (e.g., internal combustion engine or battery). The supplemental cooling devices may provide heat draw that is supplemental to the heat draw provided by other components of the fluid conditioning system (e.g., fan and radiator). For example, air that is heated by a heater core may be further heated by a supplemental heating device.

The heating devices may include one or more resistance elements (e.g., positive temperature coefficient elements), one or more thermoelectric elements, or both. The cooling devices may include one or more thermoelectric elements, fan and radiator systems, or both.

The dual-flow climatization system may fluidly communicate with a hot-side and/or cool-side of the fluid conditioning system. The dual-flow climatization system may comprise one or more supply conduits and one or more return conduits that couple to one or more conduits of the hot-side and/or one or more conduits of the cold-side. The supply conduit may function to transport a working fluid from a fluid conditioning system to the dual-flow climatization system. The return conduit may function to transport a working fluid from the dual-flow climatization system to the fluid conditioning system. The supply conduit may transport working fluid to one or more heat exchangers of the dual-flow climatization system. The return conduit may transport the working fluid from one or more heat exchangers of the dual-flow climatization system.

The heat exchanger of the dual-flow climatization system may exchange heat with air. The heat exchanger may heat air by thermally communicating relative to a working fluid from the hot-side of the fluid conditioning system. The heat exchanger may cool air by thermally communicating relative to a working fluid from the cold-side of the fluid conditioning system.

The dual-flow climatization system may include one or more, or more preferably two or more heat exchangers. At least one heat exchanger may be supplied by the hot-side of the fluid conditioning system and at least one heat exchanger may be supplied by the cold-side of the fluid conditioning system. Air may be selectively directed to the hot-side supplied heat exchanger, the cold-side heat exchanger, or both. Air that is directed to a hot-side heat exchanger and air that is directed to a cold-side heat exchanger may be mixed downstream of the heat exchangers.

The present disclosure contemplates that one heat exchanger is employed. In this regard, the heat exchanger may comprise two separate conduits for fluidic communication with the hot-side and cold-side, respectively, or the heat exchanger fluidly communicates exclusively with the hot-side or the cold-side. The heat exchanger may comprise a thermally insulating material separating the structure associated with the hot-side and the structure associated with the cold-side. In this regard, heat may be prevented from migrating from the structure associated with the hot-side to the structure associated with the cold-side.

The present disclosure provides for a dual-flow climatization system and a climatized vehicle component (e.g., a seat) comprising the same. The dual-flow climatization system may function to generate airflow, heat and/or cool air, mix air, deliver air to a vehicle occupant, or any combination thereof.

The dual-flow climatization system may supply air to a climatized vehicle component (e.g., a seat). The dual-flow climatization system may supply air to one or more air delivery devices (e.g., a port and/or air distribution device of a climatized vehicle seat). The dual-flow climatization system may supply air to one or more air delivery devices. In some aspects, the dual-flow climatization system may supply air to at least two air delivery devices. The dual-flow climatization system may supply air to a seat bottom, a seat back, a headrest, or any combination thereof. The dual-flow climatization system may supply air to two or more of a seat bottom, a seat back, and a headrest.

The dual-flow climatization system may be located on, in, or proximate to a climatized vehicle seat. The dual-flow climatization system may be remote from a climatized vehicle seat. The dual-flow climatization system may be located on, in, or proximate to an underside of a climatized vehicle seat. The unique physical configuration of the dual-flow climatization system according to the present teachings provide the system with a packaging size suitable for being located on, in, or proximate to an underside of a climatized vehicle seat. The present disclosure contemplates that the unique physical configuration of the dual-flow climatization system may provide the system with a packaging size suitable for being located on, in, or proximate to any vehicle components residing within the cabin of the vehicle.

The dual-flow climatization system may comprise a unitary structure by which at least two separate airstreams are heated, cooled, and/or transported and supplied to different regions of a climatized vehicle component. The dual-flow climatization system may heat, cool, and/or transport at least two separate airflows that travel through discrete conduits both before and after the airflows interact with one or more heat exchangers and/or bypass channels.

The dual-flow climatization system may intake ambient air from a cabin of a vehicle. The dual-flow climatization system may intake ambient air from an underside of a climatized vehicle seat.

The dual-flow climatization system may direct one or more airstreams through one or more heat exchangers and/or bypass channels. In some aspects, the dual-flow climatization system may direct at least two airstreams through one or more heat exchangers and/or bypass channels. At least one airstream may be provided to a heat exchanger in a first direction and at least one airstream may be provided to a heat exchanger in a second direction. In this regard, the present disclosure may refer to such arrangement as a cross-flow climatization system. The first direction may oppose the second direction. The first direction and the second direction may be generally parallel to one another. Airstreams may be provided to one or more heat exchangers in the same direction.

The dual-flow climatization system may comprise one or more air movers, conduits, air directing units, heat exchangers, supply conduits, return conduits, bypass channels, dividers, air directing members, actuators, arms, conduits, air delivery devices, or any combination thereof.

The dual-flow climatization system may comprise one or more air movers. The air mover may function to produce an air flow. The air mover may include an inlet and an outlet. The inlet may be in fluid communication with a cabin of a vehicle. The outlet may be in fluid communication with one or more conduits that are coupled to the air delivery device and/or an air directing unit according to the present teachings.

The air mover may be a fan, blower, or the like. The fan and/or blower may be radial-type or axial-type. The radial-type may include an impeller that intakes air in a first direction and expels air in a second direction that is generally oriented 90° from the first direction. The axial-type may include an impeller that intakes and expels air along a single axis.

The dual-flow climatization system may comprise at least two air movers. The at least two air movers may each supply an airstream to an air directing unit. At least a first air mover may supply a heat exchanger an airstream travelling in a first direction and at least a second air mover may supply a heat exchanger an airstream travelling in a second direction. The first direction may oppose the second direction. The first direction may be generally parallel to the second direction. Air movers may supply airstreams to one or more heat exchangers in the same direction.

One or more air movers may produce a maximum airflow (i.e., a volume of air per unit time) that is generally equal to or different from one or more other air movers, as determined with generally equal impeller speed. The air mover may be configured to provide an airflow that is suitable for the one or more air delivery devices supplied air by the air mover. For example, a larger port may require a larger maximum airflow relative to a smaller port.

The dual-flow climatization system may comprise one air mover. The air mover may provide air to both a first portion and a second portion of an air directing unit. The air mover may provide air to both a first side and a second side of an air directing unit. The air mover may fluidly communicate with a conduit that splits into a first conduit and a second conduit. The first conduit may supply air to a first portion of an air directing unit. The second conduit may supply air to a second portion of an air directing unit.

The air movers may be generally co-planar with an air directing unit and one or more conduits coupled to both the air delivery device and the air directing unit. The air movers may be located proximate to opposing sides of the air directing unit. The air movers may be located proximate to adjacent sides of the air directing unit. The air movers may be located on a common side of the air directing unit.

The conduits coupled to both the air delivery device and the air directing unit may be bent and/or curved. The conduits may be bent and/or curved at an angle of about 30° or more, 50° or more, or even 70° or more. The conduit may be bent at an angle of about 130° or less, 110° or less, or even 90° or less.

The dual-flow climatization system may comprise an air directing unit. The air directing unit may function to route two or more airstreams through one or both of a heat exchanger and a bypass channel, mix two or more airstreams, or both. The air directing unit may be disposed downstream of one or more air movers. The air directing unit may be disposed downstream of a conduit coupled to an air mover. The air directing unit may be disposed upstream of an air delivery device. The air directing unit may be disposed upstream of a conduit providing fluid to an air delivery device.

The air directing unit and one or more components thereof, as described herein, may be employed in the dual-flow climatization system and/or elsewhere in a vehicle. That is, two or more air directing units may be employed in a vehicle. At least one air directing unit may be associated with the dual-flow climatization system. At least one air directing unit may be located remote from the dual-flow climatization system.

The air directing unit may direct air to one or more air delivery devices (e.g., ports or air distribution devices). The air directing unit may selectively direct air to one or more vehicle occupants. For example, in a first mode, an air directing member may direct air to a port located in the front of a seat back and in a second mode, an air directing member may direct air to a port located in the rear of a seat back. In the former instance, air may be directed to the occupant of the climatized vehicle seat. In the latter instance, air may be directed to a vehicle occupant located behind the climatized vehicle seat.

The air directing unit may be located in a vehicle seat. The air directing unit may be located in a seat back, seat bottom, headrest, or any combination thereof.

The air directing unit may be located proximate to one or more air delivery devices. The air directing unit may be located downstream of the dual-flow climatization system. The air directing unit may be supplied air by one or more conduits. The air directing unit may deliver air to two or more conduits. The conduits located downstream of the air directing unit may each feed to an air delivery device.

The air directing unit may include at least a first portion and a second portion. The first portion may fluidly communicate with a first air mover and the second portion may fluidly communicate with a second air mover. The first and second portions may fluidly communicate with the same air mover. The first portion may fluidly communicate with one or more first air delivery devices and the second portion may fluidly communicate with one or more second air delivery devices.

The dimensions (i.e., length, width, height) of one or more portions may be generally equal to, smaller than, or larger than one or more other portions. The dimensions may be proportional to the airflow (i.e., volume of air per unit time) delivered by the air mover and travelling through the portion.

The air directing unit may include one or more inlets and one or more outlets. Air may enter the air directing unit via the inlet and exit the air directing unit via the outlet.

The inlet of a portion may be on an opposing side of the air directing unit from the outlet of the portion. The inlet of a portion may be on an adjacent side of the air directing unit from the outlet of the portion.

The inlet of a first portion may be on an opposing side of the air directing unit from the inlet of a second portion. The inlet of a first portion may be on the same side of the air directing unit as the inlet of a second portion. The outlet of a first portion may be on an opposing side of the air directing unit from the outlet of a second portion. The outlet of a first portion may be on the same side of the air directing unit as the outlet of a second portion.

The air directing unit may include a barrier. The barrier may be located between adjacent portions of the air directing unit. The barrier may function to at least partially prevent mixing of individual airstreams of each adjacent portion of the air directing unit. The air directing unit may be free of a barrier.

The barrier may extend at least partially between opposing sides of the air directing unit. The barrier may extend at least partially between an inlet and an outlet of the air directing unit. The barrier may extend vertically, with respect to the ground upon which a vehicle is situated. The barrier may extend horizontally, with respect to the ground upon which a vehicle is situated. The barrier may extend at an angle, with respect to the ground upon which a vehicle is situated.

The air directing unit may be unitary with one or more conduits coupled to one or more air movers and/or one or more conduits coupled to one or more air delivery devices. One or more conduits may be integrally formed to the air directing unit. The conduits and air directing unit may be fabricated by a molding process. The molding process may include injection molding, co-injection molding, blow molding, and/or overmolding.

The air directing unit may be structurally discrete from one or more conduits. The structurally discrete conduits may be fastened to the air directing unit. The conduits may be fastened with mechanical fasteners, chemical fasteners, or both. The mechanical fasteners may include one or more screws, bolts, rivets, clips, snap-fit joints, the like, or any combination thereof. The chemical fasteners may include epoxy adhesive, cyanoacrylate adhesive, polyurethane adhesive, welding, the like, or any combination thereof. One or more gaskets may be disposed between the air directing unit and conduits.

The air directing unit may comprise one or more heat exchangers, bypass channels, barriers, dividers, air directing members, actuators, arms, or any combination thereof.

The air directing unit may comprise one or more heat exchangers. The heat exchanger may function to exchange heat with one or more airstreams or even two or more airstreams. The heat exchanger may be an active-type heat exchanger. As referred to herein, an active-type heat exchanger utilizes internally flowing working fluid for the supply of heat to and/or the transportation of heat from the heat exchanger.

The heat exchanger may include one or more tubes and/or one or more fins. A working fluid may travel through the tubes. The working fluid may provide heat to or transport heat from the heat exchanger. The working fluid may be provided to the tubes by a supply conduit. The working fluid may be transported away from the tubes by a return conduit. The tubes may serpentine through the heat exchanger. The tubes may at least partially span opposing sides of the heat exchanger one or more, two or more, three or more times, or even four or more times.

The fins may conduct heat. The fins may be in thermally conductive relationship with the tubes. The fins may be configured to exchange heat with one or more airstreams. The fins may provide a larger surface area for heat exchange with airstreams relative to the surface area of the tubes. Any suitable configuration of fins may be employed with the present teachings. The fins may extend straight from one end to an opposing end of the heat exchanger. The fins may be corrugated. The corrugated fins may be folded-over toward one another in an alternating arrangement creating a series of ridges and valleys. The fins may project from a first side of the heat exchanger to a second side of the heat exchanger. Air may flow through gaps defined by the fins.

The air directing unit may comprise one or more bypass channels. The bypass channel may function to substantially maintain a temperature of an airstream from an inlet of the air directing unit to an outlet of the air directing unit. Substantially, in the context of air temperature travelling through the bypass channel, may refer to a negligible (i.e., ±3°) temperature change, if any, as heat is exchanged between the airstream and internal surfaces of the air directing unit. The bypass channel may be defined by a space between a heat exchanger, divider, and/or structural walls of the air directing unit. The bypass channel may be located above, below, or lateral to the heat exchanger.

The air directing unit may comprise one or more dividers. The divider may function to separate the heat exchanger from the bypass channel. The divider may be located between the heat exchanger and the bypass channel. The divider may cooperate with one or more structural walls of the air directing unit to define the bypass channel.

The divider may be unitary with the air directing unit. The divider may be integrally formed to the air directing unit. The divider and air directing unit may be fabricated by a molding process. The molding process may include injection molding, co-injection molding, and/or overmolding.

The divider may be structurally discrete from the air directing unit. The structurally discrete divider may be fastened to the air directing unit. The divider may be fastened with mechanical fasteners, chemical fasteners, or both. The mechanical fasteners may include one or more screws, bolts, rivets, clips, snap-fit joints, friction-fit joints, the like, or any combination thereof. The chemical fasteners may include epoxy adhesive, cyanoacrylate adhesive, polyurethane adhesive, welding, the like, or any combination thereof.

The air directing unit may comprise one or more air directing members. The air directing member may function to route one or more airstreams to a heat exchanger, bypass channel, or both. The air directing member may translate about a rotational axis. The air directing member may completely block access of an airstream to a heat exchanger or a bypass channel. The air directing member may partially block access of an airstream to a heat exchanger and/or a bypass channel. The air directing member may provide an airstream generally equal access to a heat exchanger and a bypass channel.

An air directing member may be located in both a first portion and a second portion of the air directing unit. Where more than one air directing member is employed, each air directing member may be located in a respective portion of the air directing unit. Where more than one air directing member is employed, they may act in unison and/or independently of each other. Air directing members acting in unison may be coupled, by one or more linkages, to the same actuator.

The air directing member may be in the form of a door or flap.

The door may include one or more planar or curved members. The planar or curved members may block or obstruct one or more airflows. The planar or curved members may be radially distanced from the rotational axis. The planar or curved members may be coupled to a base. The base may extend from the planar or curved members to the rotational axis. The base may be coupled to an arm at the rotational axis. In some aspects, two planar or curved members may be employed. In this regard, the two members may be located on opposing sides of the door. Examples of suitable air directing members in the form of a door are provided in International Publication Nos. WO 2021/127316 A1 and WO 2021/127314 A1, incorporated herein by reference in their entirety for all purposes.

The flap may include a planar or curved member. The planar or curved member may block or obstruct one or more airflows. The planar member may comprise two opposing ends. One end may be located along the rotational axis. One end may be coupled to an arm. The rotational axis may extend through a point between the two opposing ends. A point between the two opposing ends may be coupled to an arm. Examples of suitable air directing members in the form of a flap are provided in International Publication No. WO 2021/127314 A1, incorporated herein by reference in their entirety for all purposes.

The air directing member may be coupled directly or indirectly to an arm. The air directing member may be coupled indirectly to an arm via one or more linkages. The arm may translate the air directing member about the rotational axis. The arm may be co-axial with the rotational axis. The arm may extend at least partially between a first side of the air directing unit and an opposing second side of the air directing unit.

The arm may be directly or indirectly coupled to an actuator. The arm may be directly coupled to the actuator. The arm may be indirectly coupled to the actuator via one or more linkages. The linkages may include links, cams, pivots, the like, or any combination thereof. The arm may be an elongate member. The arm may be a rod.

The air directing unit may comprise one or more actuators. The actuator may function to move the air directing member. The actuator may rotate, move, slide, displace, reposition, or otherwise move the air directing member between positions. The actuator may move the air directing member to a plurality of positions. The actuator may move the air directing member to completely block or obstruct a heat exchanger. The actuator may move the air directing member to completely block or obstruct a bypass channel. The actuator may move the air directing member to partially block or obstruct a heat exchanger and/or a bypass channel.

The actuator may be directly or indirectly coupled to an arm. The actuator may be indirectly coupled to the air directing member via an arm and/or one or more linkages. The actuator may include one or more links, cams, pivots, bends, joints, bearings, or other like members to assist with moving the door between the one or more positions.

The actuators may act in unison or independent of each other. Where more than one air directing member is employed, each air directing member may be associated with a separate actuator and/or arm, or the same actuator and/or arm.

The actuator may be located on an exterior of the air directing unit. The actuator may be located within a footprint of the air directing unit. This may reduce packaging space required for the system, reduce the number of linkages between the air directing member and the actuator. As a result, the cost, weight, and complexity of the dual-flow climatization system may be reduced. This may also reduce the size of the actuator in that a smaller actuator may be used relative to the size of the actuator located on an exterior of the air directing unit.

The actuator may comprise a motor, a computer or controller, one or more linkages, or a combination thereof. The motor may be a stepper motor or a servo motor. The computer, whether part of the actuator, or electrically connected to the actuator, may be configured to determine a position of one or more air directing members relative to one or more inlets of the air directing unit and/or control the position of one or more air directing members. The computer may comprise a memory, a processor, a circuit board, or any combination thereof. Based on one or more temperature measurements from one or more sensors in the vehicle and a temperature set by an occupant and/or an autonomous system, the air directing unit may move one or more air directing members relative to one or more inlets of the air directing unit to adjust a proportion of fluid routed to a heat exchanger and/or a bypass channel. By way of this adjustment, a temperature of air exiting the air directing unit can be adjusted or fine-tuned, without the need for additional heaters or coolers downstream of the air directing unit.

The computer may comprise a circuit board or the circuit board may comprise a computer. The computer and/or circuit board may receive one or more communication signals from a vehicle control unit or other computer to turn the air mover and/or mixer ON and OFF, adjust a speed of the air mover, and/or adjust a position of one or more air directing members. The computer and/or circuit board may receive one or more power signals from a vehicle control unit or other computer in the vehicle to turn the air mover and/or air mixer ON and OFF, adjust a speed of the air mover, adjust a position of one or more air directing members, or any combination thereof.

The computer and/or circuit board may include a plug with one or more prongs, pins, or other suitable conductors to connect to the vehicle controller. The computer and/or circuit board may be located within the same housing as the air mover, the air directing unit, or both. The computer and/or circuit board may be located in a housing that is integrally formed with the housing of the air mover and/or air directing unit or attached thereto via one or more mechanical and/or chemical fasteners. The computer and/or circuit board may function to send signals to a vehicle controller or a vehicle computer regarding an operating speed of an air mover; and/or temperature of air entering and/or leaving the air directing unit and/or an air mover. The computer and/or circuit board may function to send signals to a vehicle controller and/or a vehicle computer regarding a position of one or more air directing members relative to one or more inlets of the air directing unit.

An operator of the vehicle or seat may send one or more signals to the air mover and/or air directing unit via the one or more plugs, circuit boards, computers, or any combination thereof to adjust the airflow and/or temperature expelled from the air directing unit.

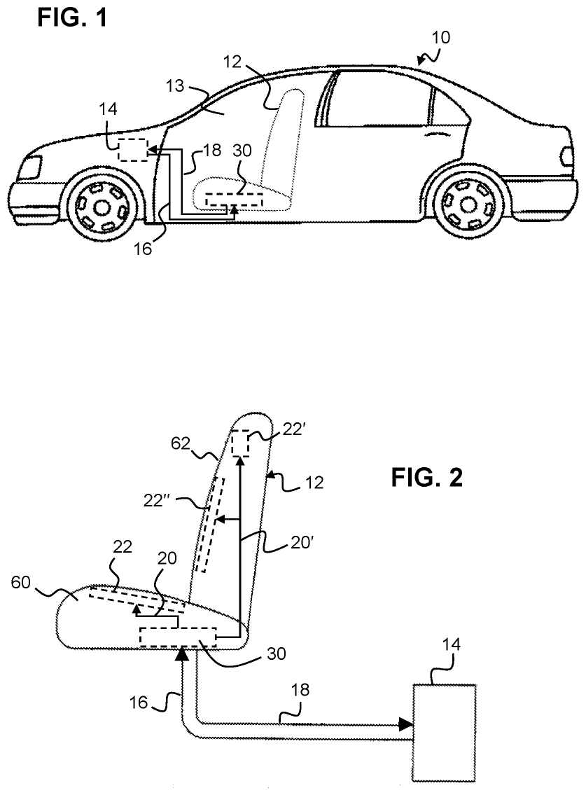

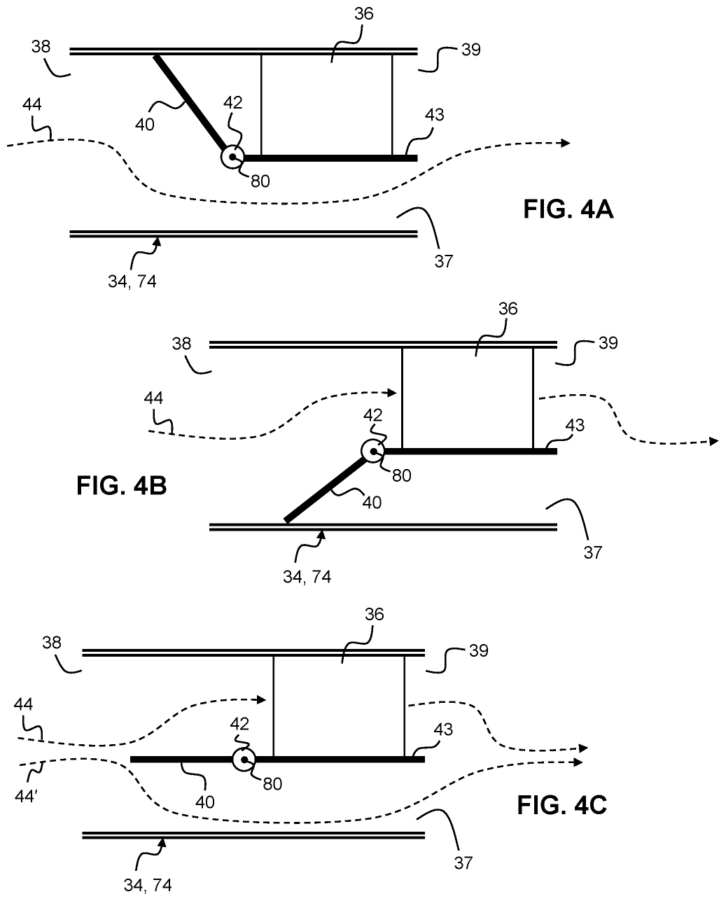

FIG. 1 is a plan view of a vehicle 10. The vehicle 10 includes a climatized vehicle seat 12 located within a cabin 13 of the vehicle. The vehicle 10 includes a fluid conditioning system 14. The fluid conditioning system 14 is located in an engine bay (or front cargo area) of the vehicle 10. The present disclosure contemplates the fluid conditioning system 14 being located anywhere within the vehicle 10 such as the cabin 13, underneath the floor of the cabin 13, or even in the rear cargo area. A dual-flow climatization system 30, which is located on-board the climatized vehicle seat 12, fluidly communicates with the fluid conditioning system 14 via a supply conduit 16 and a return conduit 18. The supply conduit 16 and return conduit 18 are coupled to a heat exchanger 36 within the dual-flow climatization system 30, as shown in FIGS. 4A-4C.

The fluid conditioning system 14 exchanges fluid with the dual-flow climatization system 30. For example, a fluid conditioning system 14, such as an engine cooling system, may exchange glycol, a glycol/water mixture, or any other suitable refrigerant with the dual-flow climatization system 30.

FIG. 2 is a plan view of a climatized vehicle seat 12. The climatized vehicle seat 12 comprises a dual-flow climatization system 30 and air delivery devices 22, 22′, 22″. An air delivery device 22 is located in a seat bottom 60 and two air delivery devices 22′, 22″ are located in a seat back 62. The air delivery device 22 directs air to a seat occupant's thighs and/or buttocks. The air delivery device 22′ directs air to a seat occupant's neck and/or shoulders. The air delivery device 22″ directs air to a seat occupant's back and/or torso. Other air delivery devices and locations thereof within the climatized vehicle seat 12, or elsewhere within the cabin, are contemplated by the present disclosure, including but not limited to ports directed to a seat occupant's calves and ports located in a headrest. The dual-flow climatization system 30 is located within the climatized vehicle seat 12 proximate to an underside of the climatized vehicle seat 12. The dual-flow climatization system 30 fluidly communicates with one or any combination of the air delivery devices 22, 22′, 22″ via conduits 20, 20′. The dual-flow climatization system 30 provides air to the air delivery devices 22, 22′, 22″.

The dual-flow climatization system 30 fluidly communicates with a fluid conditioning system 14. The fluid conditioning system 14 exchanges fluid with the dual-flow climatization system 30 via a supply conduit 16 and a return conduit 18. The fluid may include glycol, a glycol/water mixture although other fluids are contemplated by the present disclosure. The supply conduit 16 and return conduit 18 are coupled to a heat exchanger within the dual-flow climatization system 30, as shown in FIGS. 4A-4C.

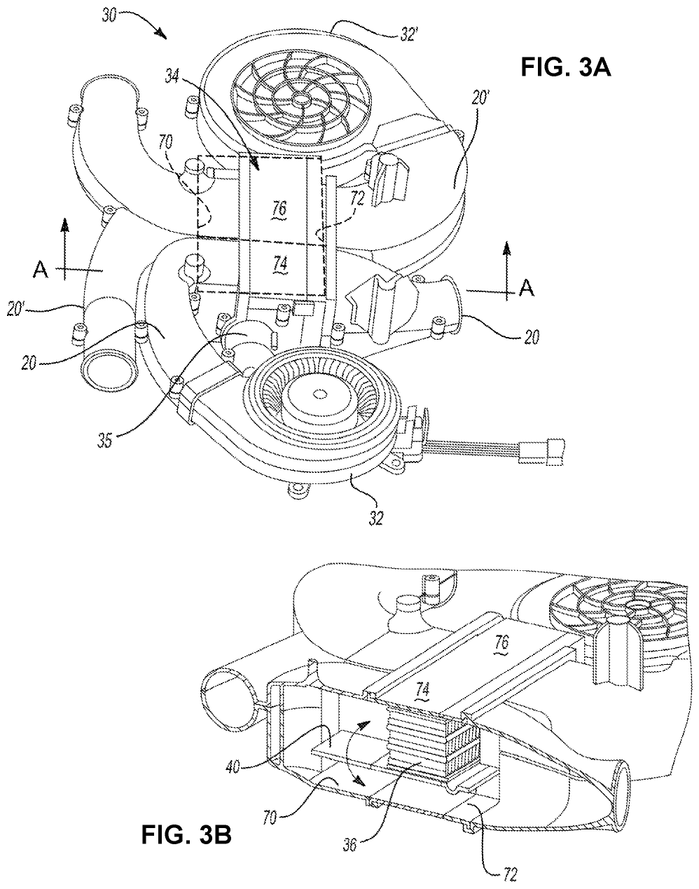

FIGS. 3A and 3B are perspective views of a dual-flow climatization system 30. The dual-flow climatization system 30 comprises two air movers 32, 32′ and an air directing unit 34 in fluid communication with one another via conduits 20, 20′. The air movers 32, 32′ intake air from the cabin 13 of the vehicle 10, particularly the underside of a climatized vehicle seat 12 as shown in FIG. 1.

The air mover 32 provides air to a first side 70 and a first portion 74 of the air directing unit 34. The air mover 32′ provides air to a second side 72 and a second portion 76 of the air directing unit 34. An airstream delivered from the air mover 32 flows in a first direction through the air directing unit 34 and an airstream delivered from the air mover 32′ flows in a second direction through the air directing unit 34. The first direction is in opposing relationship to the second direction.

Among other benefits discussed herein, the arrangement of the air movers 32, 32′, the air directing unit 34, and conduits 20, 20′ provides for a compact packing arrangement of the dual-flow climatization system 30, which aids in locating the dual-flow climatization system 30 in small packaging spaces such as on or proximate to an underside of a climatized vehicle seat 12, as shown in FIG. 2.

The dual-flow climatization system 30 comprises an actuator 35 that translates an arm 42, and indirectly an air directing member 40, about a rotational axis 80, as shown in FIGS. 4A-4C.

FIG. 3B is a perspective view of the dual-flow climatization system of FIG. 3A, whereby a section of the first portion 74 is cut away. A heat exchanger 36 is present in the first portion 74 proximate to the second side 72 of the first portion 74. An air directing member 40 is located upstream of the heat exchanger 36 and proximate to the first side 70 of the first portion 74.

FIGS. 4A-64C are sectional views of a first portion 74 of an air directing unit 34 along the line A-A of FIG. 3A. The air directing unit 34 comprises a heat exchanger 36 and a bypass channel 37 that are separated by a divider 43. An airstream 44 enters the air directing unit 34 through an inlet 38, travels through the air directing unit 34, interacts with either or both of the heat exchanger 36 and the bypass channel 37, and exits the air directing unit 34 through an outlet 39. The second portion 76 of the air directing unit 34 is identical to the first portion 74 illustrated in FIGS. 4A-4C with the exception that the airstream 44 travels in the opposing direction and thus the positions of the inlet 38 and outlet 39 are inverted.

The air directing unit 34 comprises an air directing member 40 translatable about a rotational axis 80. The air directing member 40 is coupled to an arm 42, which is angularly translated about the rotational axis 80 by an actuator 35, as shown in FIG. 3A.

In FIG. 4A, the air directing member 40 blocks the airstream 44 from interacting with the heat exchanger 36 and routes the airstream 44 to the bypass channel 37. The temperature of the airstream 44 is substantially maintained from the inlet 38 to the outlet 39.

In FIG. 4B, the air directing member 40 blocks the airstream 44 from entering the bypass channel 37 and routes the airstream 44 to the heat exchanger 36. The temperature of the airstream 44 exiting through the outlet 39 may be greater than or less than the temperature of the airstream 44 entering the inlet 38 due to heat exchange between the airstream 44 and the heat exchanger 36. The heat exchanger 36 may transfer heat to the airstream 44 or the airstream 44 may transfer heat to the heat exchanger 36.

In FIG. 4C, the air directing member 40 provides air entering the inlet 38 unobstructed access to both the heat exchanger 36 and the bypass channel 37. A first airstream 44 is routed to the heat exchanger 36 and a second airstream 44′ is routed to the bypass channel 37. The temperature of the first airstream 44 travelling to the outlet 39 through the heat exchanger 36 may be greater than or less than the temperature of the first airstream 44 entering the inlet 38 as a result of heat exchange between the first airstream 44 and the heat exchanger 36. The temperature of the second airstream 44′ travelling through the bypass channel 37 is substantially maintained from the inlet 38 to the outlet 39. After exiting the outlet 39, the first and second airstreams 44, 44′ mix.

The air directing member 40 may be angularly oriented at any position intermediate to those positions illustrated in FIGS. 4A-4C. Changing the angular position of the air directing member 40 modulates the temperature of the airstream 44 exiting the outlet 39 by either routing the airstream 44 exclusively through the heat exchanger 36 or the bypass channel 37 or causing the airstream 44 routed through the heat exchanger 36 to mix with the airstream 44′ routed through the bypass channel 37.

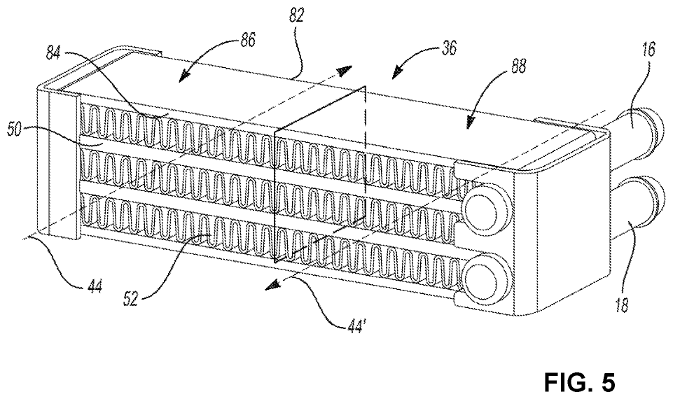

FIG. 5 is a perspective view of a heat exchanger 36. The heat exchanger 36 is supplied with a working fluid from a fluid conditioning system 14, as shown in FIG. 2, via a supply conduit 16 and returns the working fluid to the fluid conditioning system 14 via a return conduit 18. The working fluid travels through tubes 50 extending between the supply conduit 16 and the return conduit 18. The heat exchanger 36 comprises a plurality of fins 52 in thermally conductive relationship with the tubes 50. The fins 52 are corrugated, providing gaps through which air can travel. The fins 52 project from a first side 82 of the heat exchanger 36 to a second side 84 of the heat exchanger 36.

The heat exchanger 36 comprises a first portion 86 and a second portion 88. A first airstream 44 travels through the first portion 46 and a second airstream 44′ travels through the second portion 48. The direction of the first airstream 44 is in opposing relationship to the direction of the second airstream 44′. The present disclosure contemplates that the first and second airstreams 44, 44′ may travel through the heat exchanger 36 in the same direction.

The tubes 50 and fins 52 exchange heat with the airstreams 44, 44′. The temperature of the working fluid exiting the heat exchanger 36 through the return conduit 18 may be greater than or less than the temperature of the working fluid entering the heat exchanger 36 through the supply conduit 16.

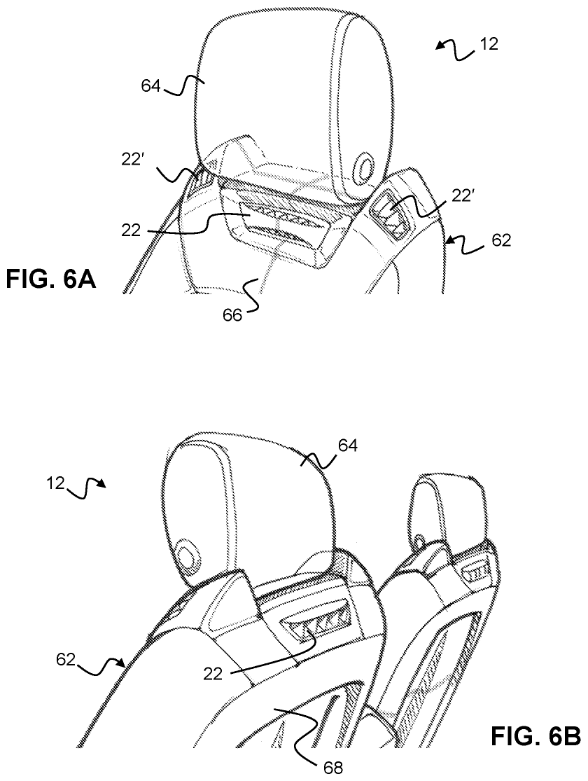

FIGS. 6A and 6B are perspective views of a climatized vehicle seat 12. An air delivery device 22 is located in the front 66 of the seat back 62 and another air delivery device 22 is located in the rear 68 of the seat back 62. The front air delivery device 22 is configured to direct air to an occupant's upper back and/or neck. The rear air delivery device 22 is configured to direct air to an occupant of a seat directly behind the depicted climatized vehicle seat 12.

Two air delivery devices 22′ are located in the front 66 of the seat back 62 and on opposing sides of a headrest 64. The air delivery devices 22′ are configured to direct air to an occupant's shoulders, head, and/or neck.

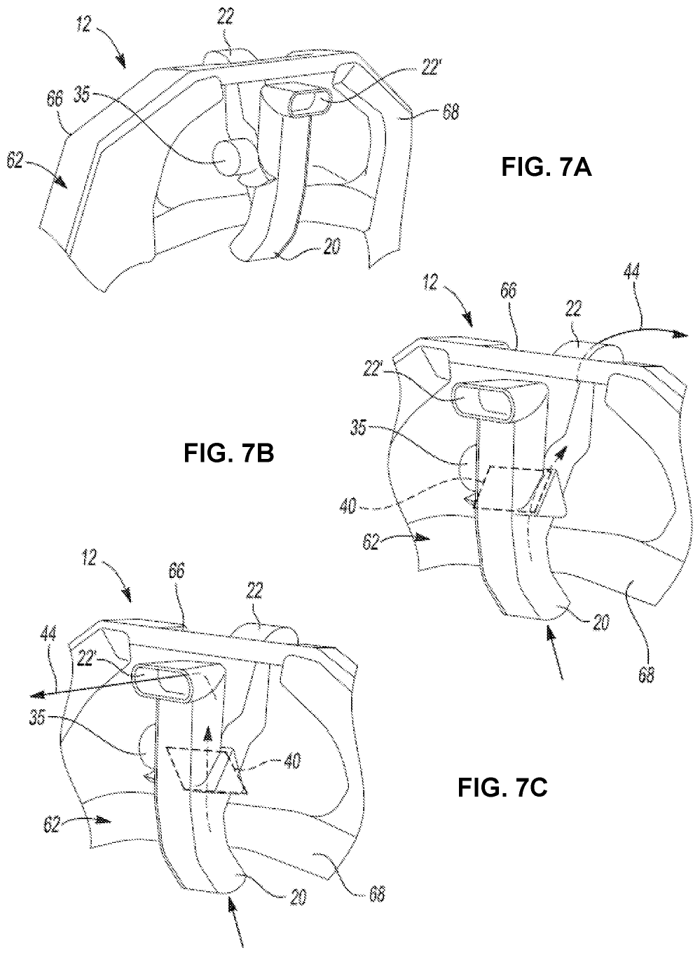

FIGS. 7A-7C are perspective views of a climatized vehicle seat 12. The climatized vehicle seat 12 comprises a first air delivery device 22 located in the front 66 of the seat back 62 and a second air delivery device 22′ located in the rear 68 of the seat back 62. The air delivery devices 22 are provided air by a conduit 20. The conduit 20 is bifurcated into a first portion that fluidly communicates with the air delivery device 22 and a second portion that fluidly communicates with the air delivery device 22′.

An air directing member 40 is located upstream of the air delivery devices 22, 22′. An actuator 35 selectively moves the air directing member 40 to a first position depicted in FIG. 7B and a second position depicted in FIG. 7C. As shown in FIG. 7B, the air directing member 40 is obstructing an airstream 44 from accessing the air delivery device 22′. As shown in FIG. 7C, the air directing member 40 is obstructing an airstream 44 from accessing the air delivery device 22.

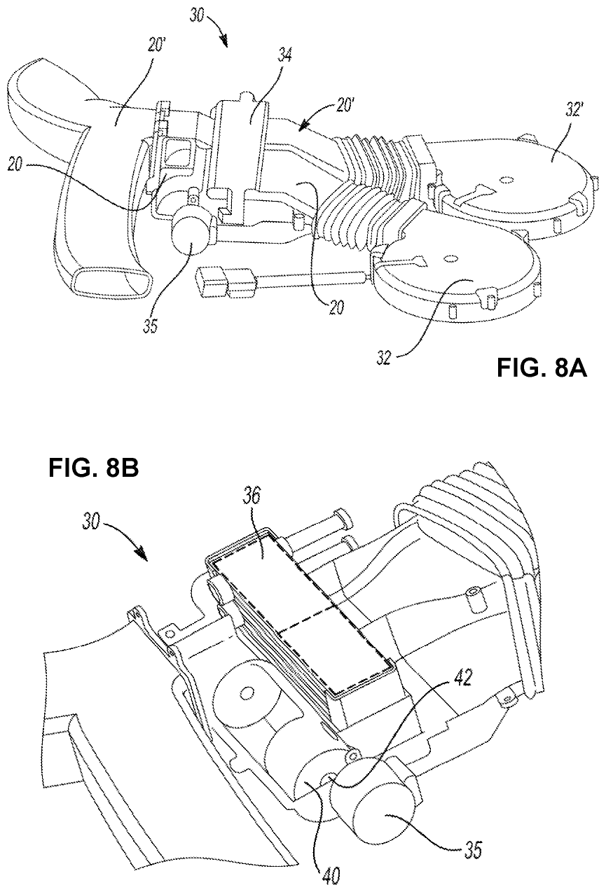

FIGS. 8A and 8B are perspective views of a dual-flow climatization system 30. The dual-flow climatization system 30 comprises two air movers 32, 32′ and an air directing unit 34 in fluid communication with one another via conduits 20, 20′. The air movers 32, 32′ intake air from the cabin 13 of the vehicle 10, particularly the underside of a climatized vehicle seat 12, as shown in FIG. 1.

Both of the air movers 32, 32′ provide air to the same side of the air directing unit 34. The airstreams delivered from both of the air movers 32, 32′ flow in the same direction through the air directing unit 34.

The dual-flow climatization system 30 comprises an actuator 35 that translates an arm 42, and indirectly an air directing member 40, depicted as a door, as shown in FIG. 8B. The air directing member 40 directs an airstream to a heat exchanger 36, a bypass channel (not shown), or both.

It is understood that any of the method steps can be performed in virtually any order. Moreover, one or more of the following method steps can be combined with other steps; can be omitted or eliminated; can be repeated; and/or can separated into individual or additional steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. Other combinations are also possible as will be gleaned from the following claims, which are also hereby incorporated by reference into this written description. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single clement or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer, or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner”, “outer”, “beneath”, “below”, “lower”, “above”, “upper”, and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

### REFERENCE NUMERALS

10 Vehicle
12 Climatized vehicle seat
13 Cabin
14 Fluid conditioning system
16 Supply conduit
18 Return conduit
20 Conduit
22 Air delivery device
30 Dual-flow climatization system
32 Air mover
34 Air directing unit
35 Actuator
36 Heat exchanger
37 Bypass channel
38 Inlet of the air directing unit
39 Outlet of the air directing unit
40 Air directing member
42 Arm
43 Divider
44 Airstream
46 First portion
48 Second portion
50 Tube
52 Fin
60 Seat bottom
62 Seat back
64 Headrest
66 Front of the seat back
68 Rear of the seat back
70 First side of the air directing unit
72 Second side of the air directing unit
74 First portion of the air directing unit
76 Second portion of the air directing unit
80 Rotational axis
82 First side of the heat exchanger
84 Second side of the heat exchanger
86 First portion of the heat exchanger
88 Second portion of the heat exchanger

What is claimed is:

1. A dual-flow climatization system comprising:
one or more air movers, and
an air directing unit comprising a heat exchanger and a bypass channel, the air directing unit including a first portion and a second portion;
wherein the one or more air movers provide a first airstream to the first portion and a second airstream to the second portion;
wherein the dual-flow climatization system is located on or proximate to a climatized vehicle seat; and
wherein all of the one or more air movers intake air from a vehicle cabin.

2. The dual-flow climatization system according to claim 1, wherein the one or more air movers provide the first airstream to the first portion in a first direction and the second airstream to the second portion in a second direction, the first direction opposing the second direction.

3. The climatized vehicle component according to claim 1, wherein the one or more air movers provide the first airstream to the first portion and the second airstream to the second portion in the same direction.

4. The dual-flow climatization system according to claim 1, wherein the heat exchanger comprises a supply conduit and a return conduit that fluidly communicates with a climatized air system, an engine cooling system, a battery cooling system, a vehicle component conditioning system, or any combination thereof; and wherein the system with which the heat exchanger fluidly communicates heats and/or cools a working fluid that is delivered to the heat exchanger.

5. The dual-flow climatization system according to claim 4, wherein the heat exchanger heats and/or cools the first airstream and the second airstream; and wherein a temperature of the first airstream and/or a temperature of the second airstream travelling through the bypass channel is substantially maintained from an inlet of the air directing unit to an outlet of the air directing unit.

6. The dual-flow climatization system according to claim 5, wherein the air directing unit comprises one or more air directing members that route the first airstream and the second airstream to the heat exchanger, the bypass channel, or both; wherein the one or more air directing members are doors or flaps; and wherein the one or more air directing members are angularly translated about a rotational axis by one or more actuators; and wherein the one or more actuators angularly translate an arm about the rotational axis, the arm being coupled to the one or more air directing members.

7. (canceled)

8. (canceled)

9. The dual-flow climatization system according to claim 6, wherein in a first mode, the air directing member routes the first airstream and/or the second airstream exclusively through the heat exchanger; wherein in a second mode, the air directing member routes the first airstream and/or the second airstream exclusively through the bypass channel; and wherein in one or more third modes, the air directing member routes the first airstream and/or the second airstream through both of the heat exchanger and the bypass channel.

10. The dual-flow climatization system according to claim 9, wherein the first airstream routed through the heat exchanger and the first airstream routed through the bypass channel mix proximate to an outlet of the air directing unit; and wherein the second airstream routed through the heat exchanger and the second airstream routed through the bypass channel mix proximate to an outlet of the air directing unit.

11. (canceled)

12. (canceled)

13. (canceled)

14. A climatized vehicle seat comprising:
at least a first air delivery device and a second air delivery device to deliver air to one or more passengers, and
an air directing unit comprising an air directing member angularly translated about a rotational axis by an actuator;
wherein the air directing member routes air to the first air delivery device, the second air delivery device, or both.

15. The climatized vehicle seat according to claim 14, wherein the air directing unit is supplied the air by the dual-flow climatization system according to claim 1.

16. The climatized vehicle seat according to claim 15, wherein the air directing member is a door or a flap, and wherein the air directing member is coupled to the actuator by an arm; and wherein the actuator angularly translates the arm about the rotational axis.

17. (canceled)

18. The climatized vehicle seat according to claim 16, wherein in a first mode, the air directing member routes the air exclusively to the first air delivery device;
wherein in a second mode, the air directing member routes the air exclusively to the second air delivery device; and wherein in one or more third modes, the air directing member routes the air to both of the first air delivery device and the second air delivery device.

19. (canceled)

20. The climatized vehicle seat according to claim 18, wherein the air directing unit is located in a seat bottom, a seat back, or both.

21. The climatized vehicle seat of claim 20, wherein the first air delivery device delivers air to an occupant of a seat in which the air directing unit is located, and the second air delivery device delivers air to another vehicle occupant, wherein the first air delivery device is oriented forward and the second air delivery device is oriented rearward; and wherein a direction of air delivered by the first air delivery device opposes a direction of air delivered by the second air delivery device.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. The dual-flow climatization system according to claim 1, wherein the one or more air movers intake air from an underside of the climatized vehicle seat.

44. The dual-flow climatization system according to claim 6, wherein the one or more air directing members include two or more air directing members; and wherein the two or more air directing members are coupled to the arm; wherein the arm extends along a longitudinal axis that is parallel to a length of the heat exchanger, the length of the heat exchanger being defined by a first side of the heat exchanger located in the first portion and a second side of the heat exchanger located in the second portion; and wherein the arm and the heat exchanger extend through both of the first portion and the second portion.

45. The dual-flow climatization system according to claim 1, wherein the one or more air movers include a first air mover fluidly communicating with the first portion of the air directing unit and a second air mover fluidly communicating with the second portion of the air directing unit; wherein the air directing unit has two opposing ends including a first end on the first portion and a second end on the second portion; and wherein the first air mover is located proximate to the first end and the second air mover is located proximate to the second end.

46. The dual-flow climatization system according to claim 45, wherein the first and second air movers are generally aligned along or parallel to a longitudinal axis of the air directing unit extending through the first and second ends, the rotational axis of the arm, or both.

47. The dual-flow climatization system according to claim 46, wherein the first and second air movers comprise an outlet that is coupled via a conduit to an inlet of the air directing unit; wherein the outlets of the first and second air movers are oriented acutely to the inlets of the air directing unit.

48. The dual-flow climatization system according to claim 47, comprising a first delivery conduit in fluid communication with the first air mover and a second delivery conduit in fluid communication with the second air mover; wherein the first delivery conduit bifurcates into two sub-channels; and wherein the first air mover produces a greater maximum airflow relative to the second air mover.
